(19) United States
(12) Patent Application Publication
(10) Pub. No.: US 2011/0115410 A1
(43) Pub. Date: May 19, 2011

(54) LED LAMP FOR STREET LIGHTING UTILIZING MULTIPLE DRIVERS

(75) Inventor: Steven KIM, Riverdale, NJ (US)

(73) Assignee: LED FOLIO CORPORATION, Riverdale, NJ (US)

(21) Appl. No.: 12/619,014

(22) Filed: Nov. 16, 2009

(51) Int. Cl. H05B 37/02

(52) U.S. Cl. 315/297; 315/294

(57) ABSTRACT

Disclosed is a light emitting diode lamp including a plurality of LED modules having a plurality of LEDs, the plurality of LEDs being arranged in a plurality of zones, a plurality of drive modules each respectively providing pulsed direct current power to one of the plurality of zones, and LED lamp controller electrically connected to the plurality of drive modules.

### BACKGROUND OF THE INVENTION

1. Field of the Invention

The embodiments of the invention relate to a light emitting diode (hereinafter, abbreviated as “LED”) lamp for street lighting, and more particularly to an LED lamp for street lighting utilizing multiple drivers. Although embodiments of the invention are suitable for a wide scope of applications, they are particularly suitable for lighting applications where multiple lighting levels are desired.

2. Discussion of the Related Art

Generally, street lamps refer to lighting systems that are installed along sidewalks or roadways in order to illuminate the streets and increase traffic safety. A typical street lamp includes a light source, a lighting fixture for mounting the light source thereon, a power supply unit for supplying power to the light source, a timer, and a central control unit operated to turn the light source on and off. The light source can be either a mercury lamp, a fluorescent lamp or a sodium lamp. Such a street lamp is designed to illuminate the surrounding area above a predetermined illuminance. In recent years, LEDs have been considered for use as light sources of street lamps due to their low power consumption, semi-permanent lifetime and improved illuminance.

FIG. 1 is an exploded perspective view of an LED lamp for street lighting according to the related art. As illustrated in FIG. 1, the LED lamp includes: a transparent curved lamp cover 10 through which light is able to pass; a lamp case 20 coupled to the lamp cover 10, accommodating an electronics package 30. The electronics package 30 contains a AC/DC power converter (not shown) connected to a driver module (not shown), and is configured to drive the lamp and a plurality of LED modules 50 as light sources. The lamp case 20 is provided with a power cable port 40 through which external power is supplied to the LED modules 50 at one side thereof. A reflective plate 80 fastened to the lamp case 20 to reflect light from the LED modules 50 installed in the lamp case 20.

The lamp cover 10 is made of glass or a transparent resin through which light from the LED modules is transmitted outside the LED lamp. Each of the lamp cover 10 and the lamp case 20 has fastening holes formed at positions facing each other through which suitable fastening members, such as bolts and nuts, are assembled with each other.

The lamp case 20 has an inner space accommodating the electronics package 30 and the LED modules 50 therein and is opened at one end thereof. The lamp case 20 is curved and has a first housing portion 21. The first housing portion 21 has a hollow space in which the electronics package 30 is fixedly installed to supply power to the LED modules 50 and to drive the LED modules.

FIG. 2 is a block diagram of the drive module 31 of the LED lamp shown in FIG. 1. Referring to FIG. 2, the drive module accepts direct current power 32, a current loading signal 33, and in response, provides pulsed direct current power 34. The current loading signal 33 is produced by the LED modules (not shown) connected to the pulsed direct current power 34 and is a measure of the current that the LED modules are consuming. The drive module 31 checks the current loading state of the LED modules and varies the pulse width of the pulsed direct current power 32 so that the driving of the LED lamp can be stabilized by feedback control.

The drive module 31 contains a controller 35 and a switch 36. The controller 35 is coupled to receive a current loading signal 33 and in response produce a control signal 37. The current loading signal 33 is produced by the LED modules (not shown) and is a measure of the current that the LED modules are consuming. The switch 36 is coupled to receive the control signal 37 from the controller 35, direct current power 32, and in response, vary the pulse width of the pulsed direct current power 32 so that the driving of the LED lamp can be stabilized by feedback control.

FIG. 3 is a block diagram of the related art LED lamp. Referring to FIG. 1 and FIG. 3, an external power cable is introduced into the LED lamp through the power cable port 40. Alternating current power 11 is delivered through the power cable and passes through an internal power converter 12 to be converted to direct current power 32. The internal power converter 12 includes a line filter, a bridge diode and other electrical components. The direct current power 32 is switched by a switch 36 to produced pulsed direct current power 34 and is then supplied to the LED modules 50. The current loading signal 33 produced by the plurality of LED modules 50 is checked by the controller 35 to vary the resonant frequency of the switch 36, so that the driving of the LED lamp can be stabilized by feedback control.

FIG. 4 is a schematic representation of the related art LED lamp. Referring to FIG. 4, alternating current power 11 passes through an internal power converter 12 to be converted to direct current power 32. The internal power converter 12 includes a line filter, a bridge diode and other electrical components. The direct current power 32 is switched by a switch 36 to produced pulsed direct current power 34 which is then supplied to the LED modules 50. The current loading signal 33 produced by the plurality of LED modules 50 is checked by the controller 35 to vary the resonant frequency of the switch 36, so that the driving of the LED lamp can be stabilized by feedback control.

Although related art LED lamps can be used to substitute for their less efficient incandescent counterparts, related art LED lamps are either ON or OFF. This is in part because the electronics of related art LED lamp are not compatible with traditional dimmers of incandescent lamps. Further, the drive module of the related art LED lamp collectively monitors and controls all of the LED modules.

### SUMMARY OF THE INVENTION

Accordingly, embodiments of the invention are directed to a LED lamp for street lighting having multiple drivers that substantially obviates one or more of the problems due to limitations and disadvantages of the related art.

An object of embodiments of the invention is to provide a LED lamp with multiple drive modules.

Another object of embodiments of the invention is to provide a LED lamp having LED modules with multiple light zones.

Another object of embodiments of the invention is to provide a LED lamp having LED modules with multiple light zones wherein each light zone is independently controlled by a drive module.

Another object of embodiments of the invention is to provide a LED lamp having a control circuit to toggle the state of the drive modules to achieve multiple lighting levels from the LED lamp.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, the LED lamp for street lighting utilizing multiple drivers includes a plurality of LED modules having a plurality of LEDs, the plurality of LEDs being arranged in a plurality of zones, a plurality of drive modules each respectively providing pulsed direct current power to one of the plurality of zones, and LED lamp controller electrically connected to the plurality of drive modules.

In another aspect, the LED lamp for street lighting utilizing multiple drivers includes a method for providing multiple lighting levels from an LED lamp by providing a plurality of LED modules having a plurality of LEDs, the plurality of LEDs being arranged in a plurality of zones in each of the plurality of LED modules, connecting each one of a plurality of drive modules to one of the plurality of zones, respectively, and connecting a LED lamp controller to the plurality of LED drivers wherein the LED lamp controller controls the plurality of LED drivers to turn-on the plurality of LED groups in response to a control signal.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is an exploded perspective view of an LED lamp for street lighting according to the related art;

FIG. 2 is a block diagram of the drive module of the LED lamp shown in FIG. 1;

FIG. 3 is a block diagram of the related art LED lamp shown in FIG. 1;

FIG. 4 is a schematic representation of the related art LED lamp shown in FIG. 1;

FIG. 5 is an electrical diagram of a LED lamp according to an embodiment of the invention;

FIG. 6 is a block diagram of an electronics package according to an embodiment of the invention;

FIGS. 7a-7e illustrate an LED module having ninety-eight LEDs and four zones according to an embodiment of the invention where zones are arranged in substantially concentric rings; and

FIGS. 8a-8e illustrate an LED module having ninety-eight LEDs and four zones according to an embodiment of the invention where zones formed by substantially linear arrangements of LEDs crossing at the center of the LED module.

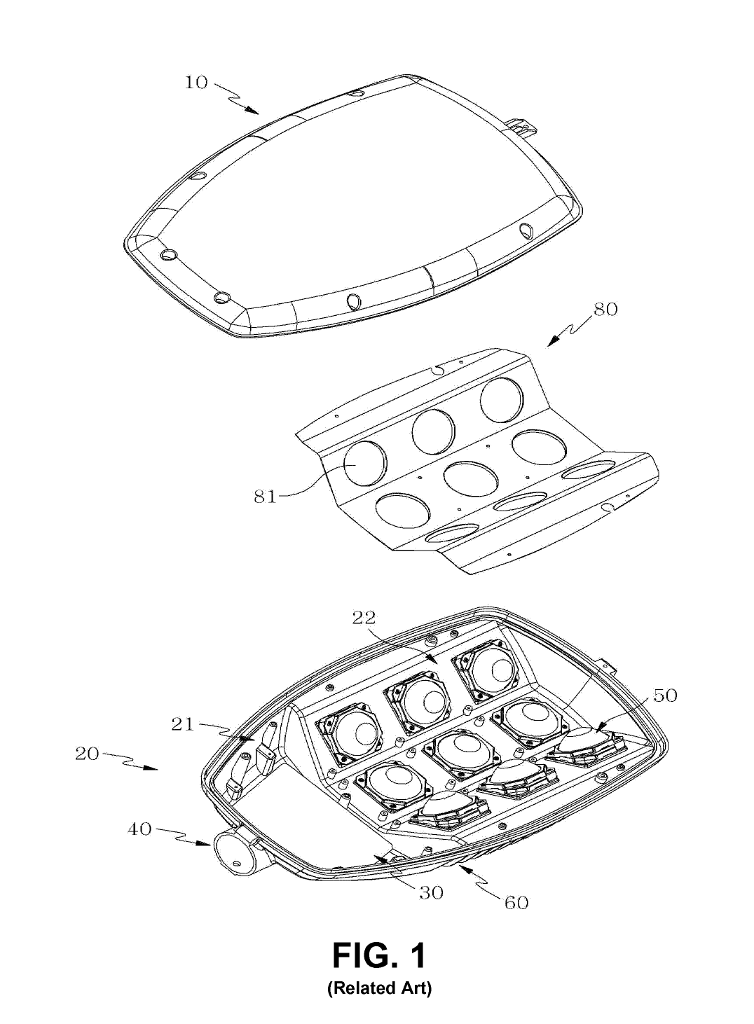

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

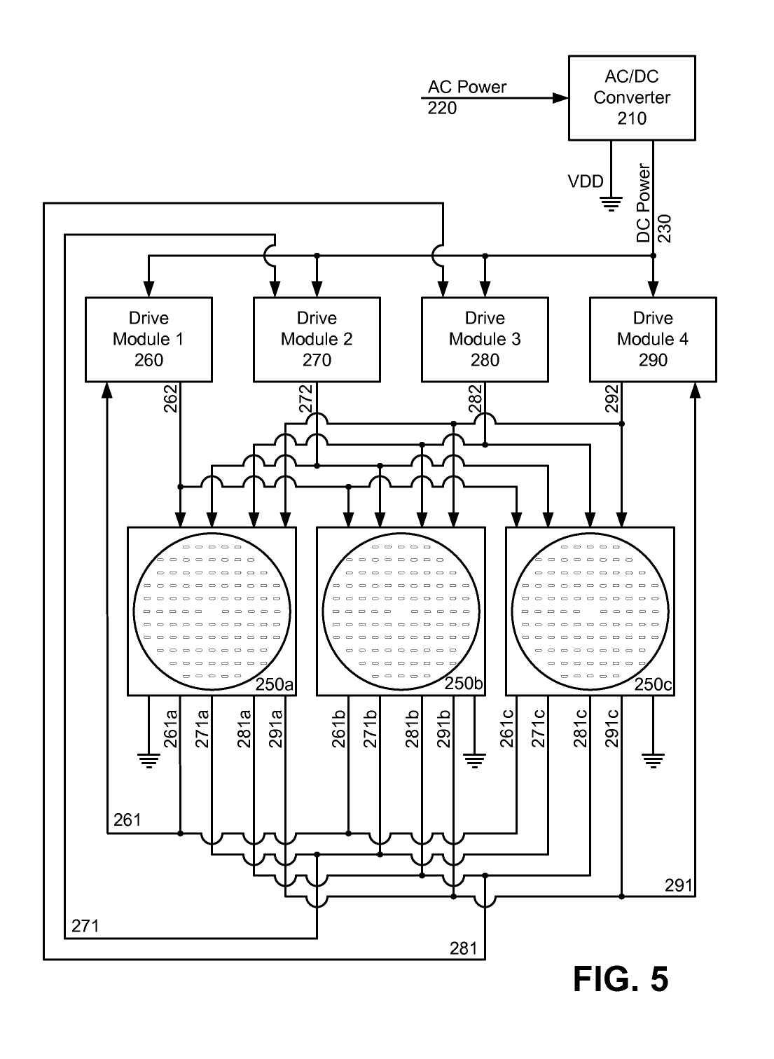

FIG. 5 is an electrical diagram of a LED lamp according to an embodiment of the invention. Referring to FIG. 5, an LED lamp includes AC/DC power converter 210, four drive modules 260, 270, 280, and 290 and three LED modules 250a-c. Each LED module has LEDs separated into four zones (not shown), which are each independently powered and each have independent current sensing taps.

The AC/DC power converter 210 receives alternating current power 220 and in response, provides direct current power 230. The AC/DC power converter 210 can include a line filter, a bridge diode and other electrical components (not shown). The drive modules 260, 270, 280, and 290 receive direct current power 230 from the AC/DC converter 210 and a current loading signal from one of the current loading signal lines 261, 271, 281, and 291 from one of the four zones (not shown) of the LED modules 250a-c. In response, the drive modules 260, 270, 280, and 290 produce pulsed direct current power delivered along lines 262, 272, 282, and 292 to be supplied to a zone (not shown) of the LED modules 250.

Each LED module 250 receives a pulsed direct current power along lines 262, 272, 282, and 292 from each of the drive modules 260, 270, 280, and 290. Within a LED module 250a-c, each pulsed direct current power line 262, 272, 282, and 292 from the drive modules 260, 270, 280, and 290 is connected to a separate zone (not shown.) The LED modules 250a-c produce a separate current loading signal for each zone from current sensing taps (not shown) of the LEDs in a zone. The current loading signals produced by the plurality of LED modules 250 are provided through lines 261, 271, 281, and 291 to be checked by the drive modules 260, 270, 280, and 290 to vary the frequency of the pulsed direct current, so that the driving of the LED lamp can be stabilized by feedback control.

LED module 250a produces current loading signals 261a, 271a, 281a, and 291a. LED module 250b produces current loading signals 261b, 271b, 281b, and 291b. LED module 250c produces current loading signals 261c, 271c, 281c, and 291c. The current loading signals 261a, 261b, and 261c are transmitted along line 261. The current loading signals 271a, 271b, and 271c are transmitted along line 271. The current loading signals 281a, 281b, and 281c are transmitted along line 281. The current loading signals 291a, 291b, and 291c are transmitted along line 291.

Each of the three LED modules 250a-c has four zones. The first zone from each LED module 250a-c is connected to the first drive module 260. The second zone from each LED module 250a-c is connected to the second drive module 270. The third zone from each LED module 250a-c is connected to the third drive module 280. The fourth zone from each LED module 250a-c is connected to the fourth drive module 290. In this embodiment, each drive module 260, 270, 280, and 290 powers a single zone of three LED modules 250a-c. The drive modules 260, 270, 280, and 290 can be turned on in succession to successively light zones of the LED modules 250a-c. As more drive modules 260, 270, 280, and 290 are turned on, the amount of light produced by the LED modules 250a-c increases thereby achieving multiple lighting levels from a single LED lamp.

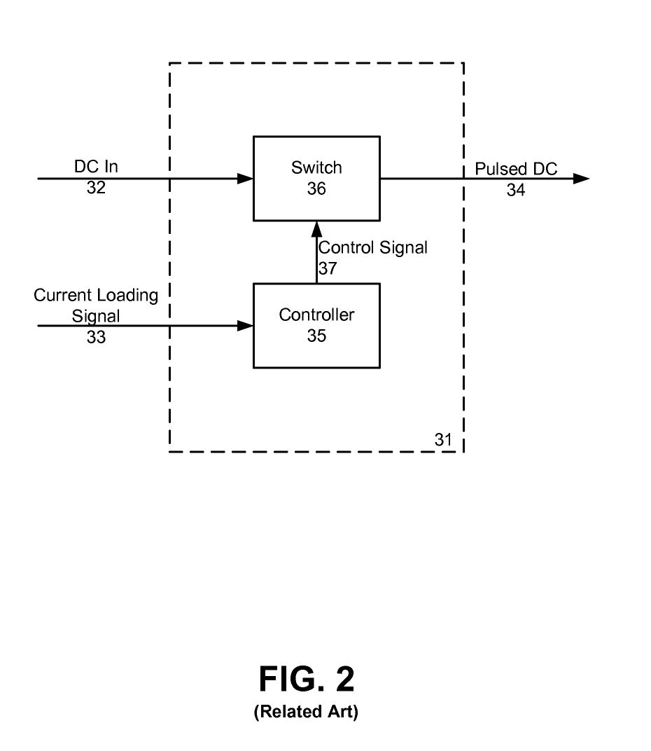

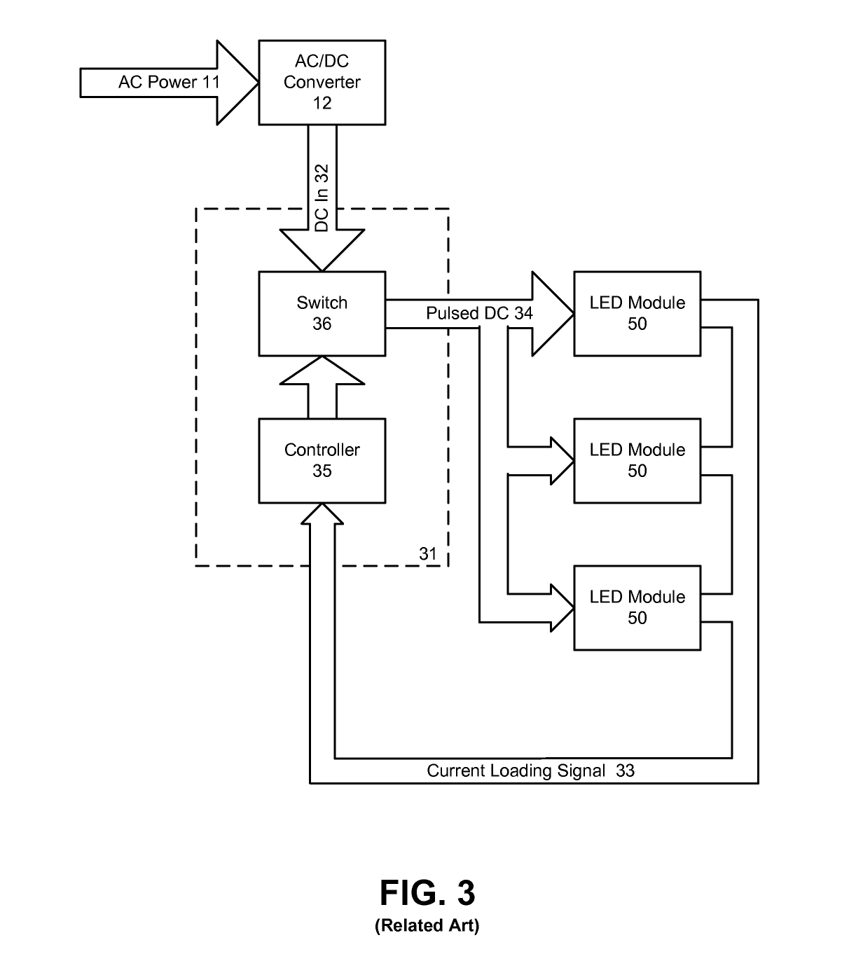

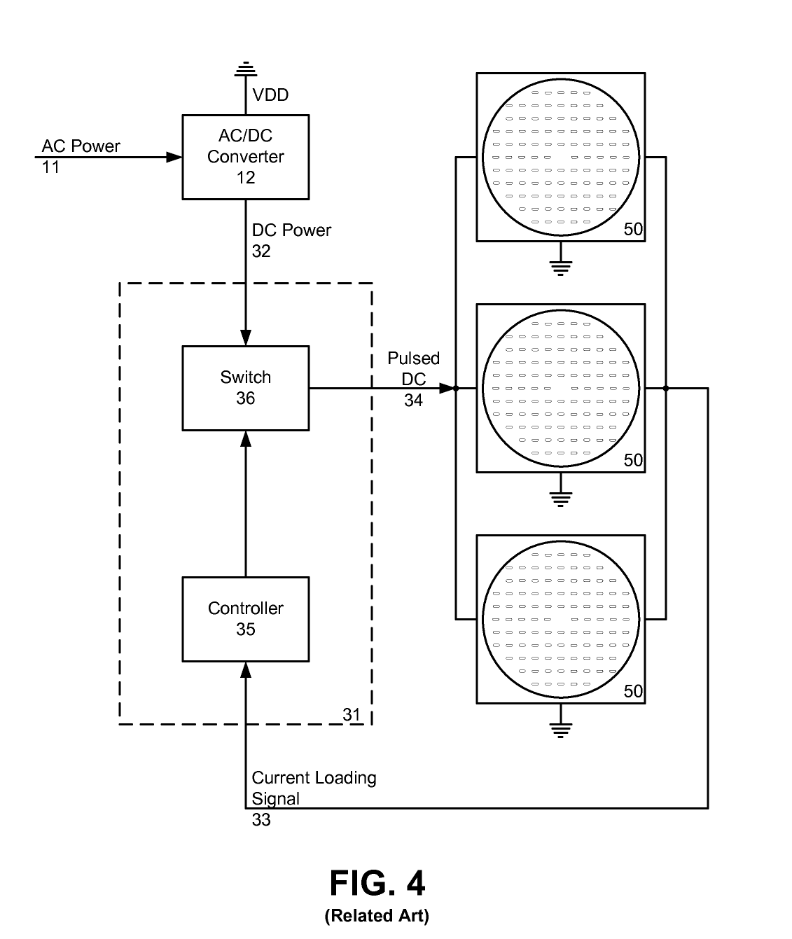

Referring back to FIG. 2, a drive module 31 contains a controller 35 and a switch 36. The controller 35 is coupled to receive a current loading signal 33 and in response produce a control signal 37. The current loading signal 33 from the LED module (not shown) is a measure of the current that the LED module is consuming. The switch 36 is coupled to receive the control signal 37 from the controller 35, direct current power 32, and in response, vary the pulse width of the pulsed direct current power 32 so that the driving of the LED lamp can be stabilized by feedback control.

While the present embodiment has three LED modules with four zones and four drive modules, variations on the number of these elements are contemplated including variations on the number of LED modules, variations on the number of zones, and variations on the number of drivers. Accordingly, the invention is not limited to presently described embodiment.

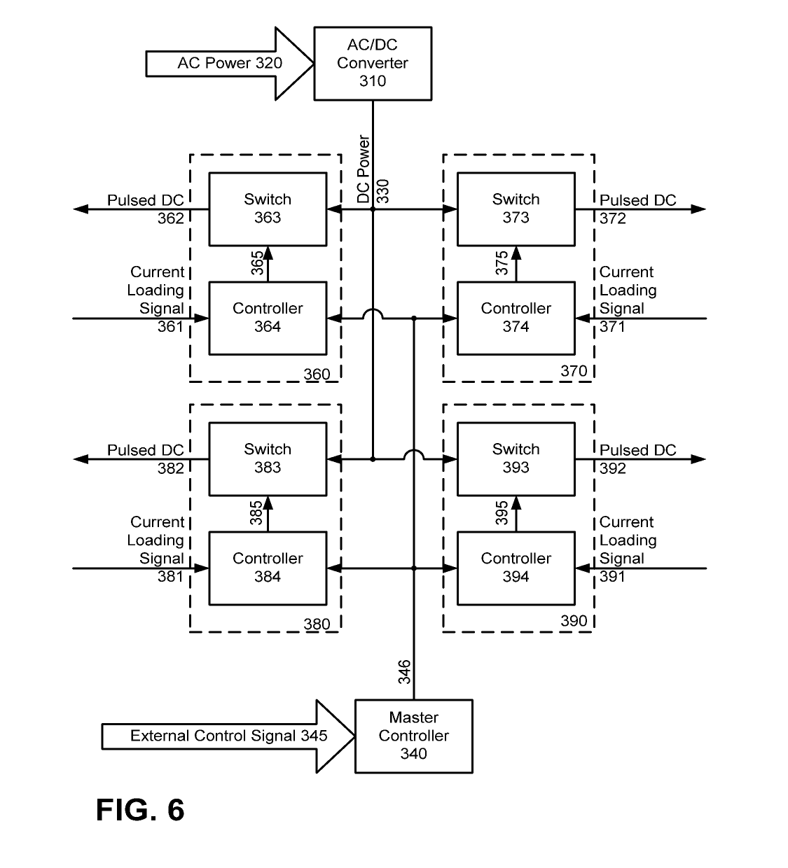

FIG. 6 is a block diagram of an electronics package according to an embodiment of the invention. As shown in FIG. 6, the electronics package includes an AC/DC converter 310 and four driver modules 360, 370, 380, and 390 and a master controller 340. Each driver module 360, 370, 380, and 390 contains a controller 364, 374, 384, and 394 and a switch 363, 373, 383, and 393.

The AC/DC power converter 310 receives alternating current power 320 and in response, provides direct current power 330 to each of the switches 363, 373, 383, and 393. The AC/DC power converter 310 can include a line filter, a bridge diode and other electrical components (not shown).

Referring to drive module 360, the controller 364 is coupled to receive a current loading signal 361, an enable signal 346, and in response, produce a control signal 365. The current loading signal 361 is produced by the LED modules (not shown) and is a measure of the current that the LED modules are consuming. The enable signal 346 is produced by the master controller 240 and instructs the controller 264 whether to output a control signal 365. The switch 363 is coupled to receive the control signal 365 from the controller 364, direct current power 330, and in response, vary the pulse width of the pulsed direct current power 362 so that the driving of the LED lamp can be stabilized by the feedback control. The operation of drive modules 370, 380, and 390 is identical to the operation of drive module 360.

The master controller 340 is connected to the controller 364, 374, 384, and 394 of each of the drive modules 360, 370, 380, and 390. The master controller receives an external control signal 345 and in response, provides an enable signal 346 to each of the controllers 364, 374, 384, and 394. Although only a single enable signal 346 is shown, it is to be understood by one of ordinary skill in the art that the enable signal 346 could be many bits wide and capable of individually addressing each of the controllers 364, 374, 384, and 394. Alternatively, a separate enable signal 346 could be provided for each of the controllers 364, 374, 384, and 394. The enable signal is provided along the signal line 346 to instruct the controllers 364, 374, 384, and 394 whether the switch 363, 373, 383, and 393 should be turned on or turned off. In this way, the master controller is capable of controlling individual zones of LEDs for the attached LED modules (not shown)

The external control signal 345 carries information used by the master controller 340 to determine which of the LED zones should be turned-on or turned-off.

In an embodiment, the external control signal 345 is supplied by a light sensor. As the light in the environment lowers, the master controller progressively turns on additional zones of the LED modules. As the light in the environment raises, the master controller progressively turns off zones of the LED modules.

In another embodiment, the external control signal 345 is supplied by a timer. In the evening, the master controller progressively turns on additional zones of the LED modules. In the morning, the master controller progressively turns off zones of the LED modules.

In another embodiment, the external control signal 345 is supplied by a connection to a communication network. The communication network may be operated by the city or municipality. The a device on the communication network may specify lighting levels to be interpreted by the master controller. In this way, multiple connected LED lamps can be controlled from a single location. This ensures that all LED lamps have the same amount of illumination at the same time.

In another embodiment, the external control signal 345 is supplied by a switch (not shown) connected to the LED lamp. The switch can be manually actuated to activate the desired lighting zones. For example, such a switch can be a five position switch having an OFF mode, one LED zone ON, two LED zones ON, three LED zones ON, and four zones ON.

In another embodiment, the external control signal 345 is supplied by a temperature sensor inside each of the LED bulbs (not shown). If the temperature of the LED modules rises beyond a critical point, the master controller 340 can turn OFF some or all of the zones.

Although multiple embodiments of external control signals have been disclosed and described, other external control signals as well as multiple and combined control signals are also contemplated. Accordingly the invention is not to be limited to the exemplary control signals herein described.

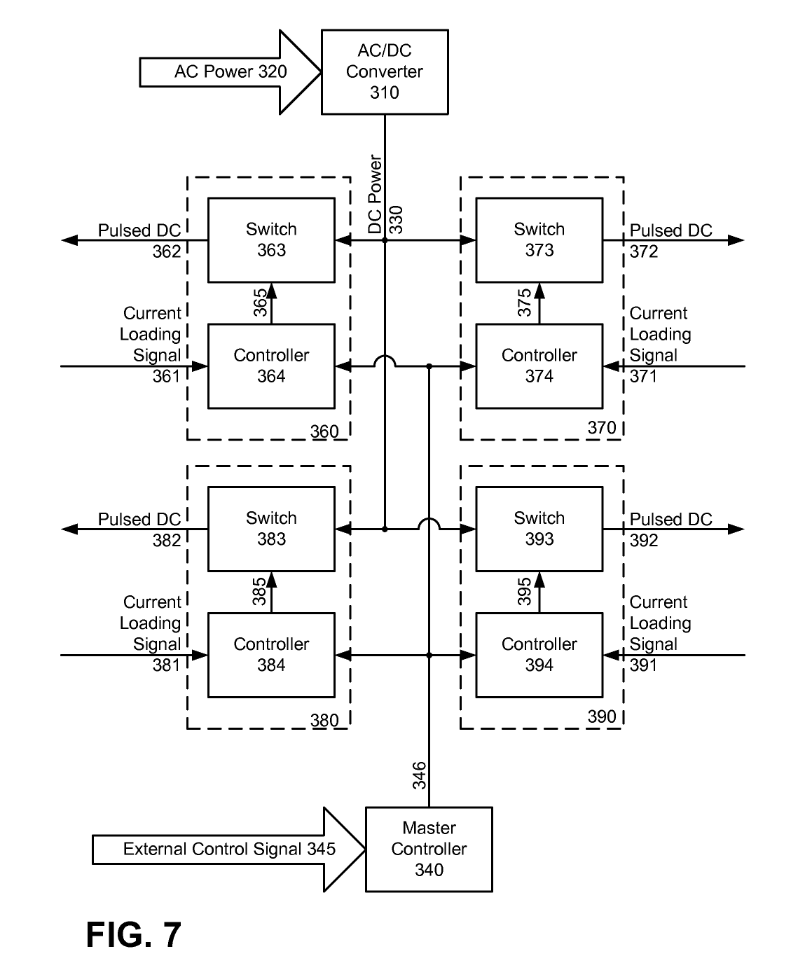

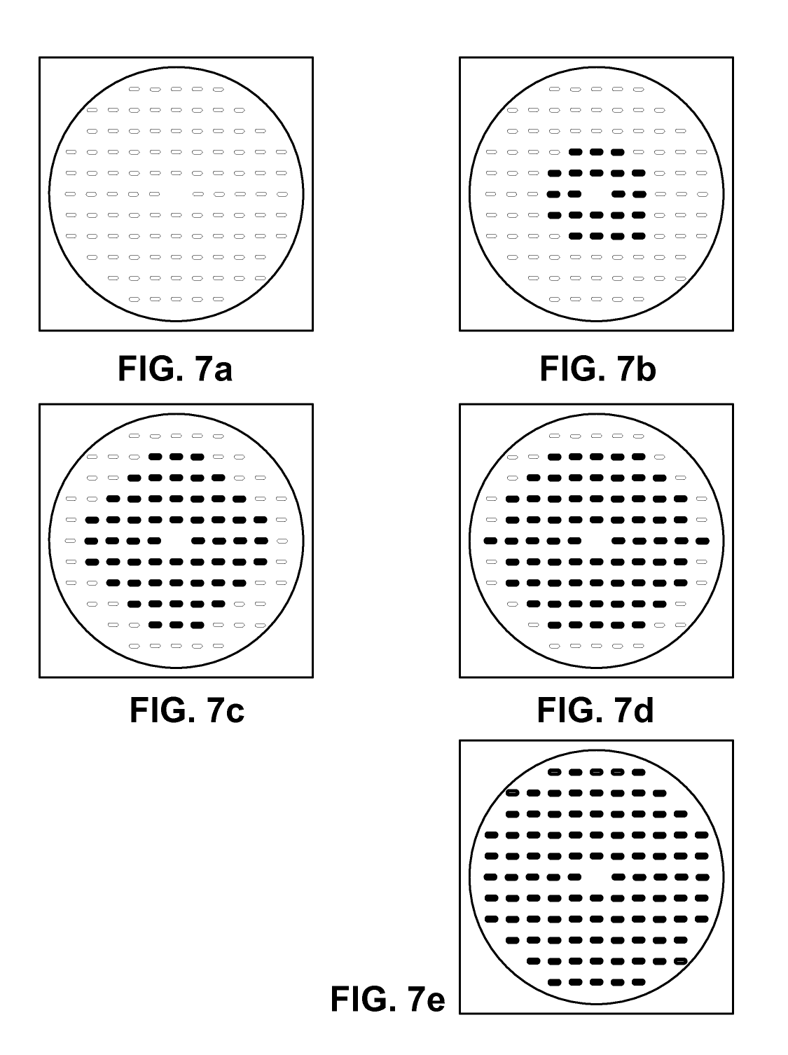

FIGS. 7a-7e illustrate an LED module having ninety-eight LEDs and four zones according to an embodiment of the invention where zones are arranged in substantially concentric rings. FIG. 7a is an illustration of an LED module having ninety-eight LEDs according to an embodiment of the invention where none of the LEDs are turned-on. FIG. 7b is an illustration of an LED module having ninety-eight LEDs according to an embodiment of the invention where twenty-one LEDs are turned-on. FIG. 7c is an illustration of an LED module having ninety-eight LEDs according to an embodiment of the invention where fifty-six LEDs are turned-on. FIG. 7d is an illustration of an LED module having ninety-eight LEDs according to an embodiment of the invention where seventy LEDs are turned-on. FIG. 7e is an illustration of an LED module having ninety-eight LEDs according to an embodiment of the invention where ninety-eight LEDs are turned-on.

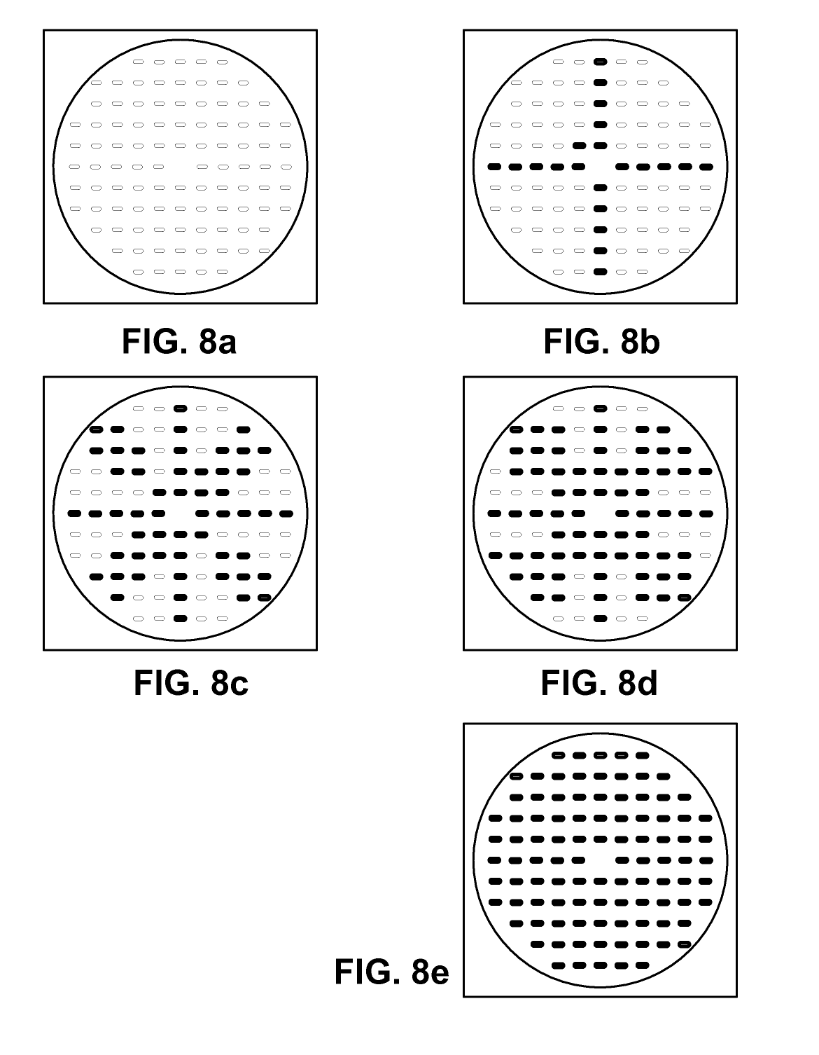

FIGS. 8a-8e illustrate an LED module having ninety-eight LEDs in four sets according to an embodiment of the invention in which each set has lines of LEDs crosses the center of the LED module. FIG. 8a is an illustration of an LED module having ninety-eight LEDs according to an embodiment of the invention where none of the LEDs are turned-on. FIG. 8b is an illustration of an LED module having ninety-eight LEDs according to an embodiment of the invention where twenty-one LEDs are turned-on. FIG. 8c is an illustration of an LED module having ninety-eight LEDs according to an embodiment of the invention where fifty-six LEDs are turned-on. FIG. 8d is an illustration of an LED module having ninety-eight LEDs according to an embodiment of the invention where seventy LEDs are turned-on. FIG. 8e is an illustration of an LED module having ninety-eight LEDs according to an embodiment of the invention where ninety-eight LEDs are turned-on.

It will be apparent to those skilled in the art that various modifications and variations can be made in the LED lamp for street lighting having multiple drivers of embodiments of the invention without departing from the spirit or scope of the invention. Thus, it is intended that embodiments of the invention cover the modifications and variations of this invention provided they come within the scope of the appended claims and their equivalents.

What is claimed is:

1. A light emitting diode lamp, comprising:
light emitting diode modules each having a plurality of light emitting diodes, the plurality of light emitting diodes are positioned in zones within each of the light emitting diode modules;
drive modules respectively connected to one of the zones in each of the plurality of light emitting diode modules; and
a light emitting diode lamp controller electrically connected to the plurality of drive modules.

2. The light emitting diode lamp according to claim 1, further comprising current sensing taps for sensing current of light emitting diodes in each of the plurality of zones connected to the plurality of drive modules.

3. The light emitting diode lamp according to claim 2, wherein the drive modules vary frequency of pulsed direct current power in response to a sensed current.

4. The light emitting diode lamp according to claim 1, wherein the zones are arranged in concentric circles on each of the light emitting diodes modules.

5. The light emitting diode lamp according to claim 1, wherein the zones each include light emitting diodes in lines crossing a center of the LED modules.

6. The light emitting diode lamp according to claim 1, wherein the light emitting diode lamp controller receives a control signal and in response, turns-on at least one of the drive modules.

7. The light emitting diode lamp according to claim 6, wherein the control signal is generated by a light sensor.

8. The light emitting diode lamp according to claim 6, wherein the control signal is generated by a timer.

9. The light emitting diode lamp according to claim 6, wherein the control signal is from a communications network.

10. The light emitting diode lamp according to claim 6, wherein the control signal is generated by a temperature sensor proximate to at least one of the light emitting diode modules.

11. A light emitting diode lamp, comprising:
a first light emitting diode module having a first plurality of light emitting diodes and a second plurality of light emitting diodes;
a first drive module electrically connected to the first plurality of light emitting diodes;
a second drive module electrically connected to the second plurality of light emitting diodes; and
a light emitting diode lamp controller electrically connected to first and second drive modules.

12. The light emitting diode lamp according to claim 11, further comprising a second light emitting diode module having a third plurality of light emitting diodes and a fourth plurality of light emitting diodes, wherein the third plurality of light emitting diodes is electrically connected to the first drive module and the fourth plurality of light emitting diodes is electrically connected to the second drive module.

13. The light emitting diode lamp according to claim 12, further comprising current sensing taps for sensing current of the first, second, third, and fourth plurality of light emitting diodes.

14. The light emitting diode lamp according to claim 13, wherein the drive modules vary frequency of pulsed direct current power in response to a sensed current.

15. The light emitting diode lamp according to claim 11, wherein the first and second plurality of light emitting diodes are arranged in concentric circles on the first light emitting diode module.

16. The light emitting diode lamp according to claim 11, wherein the light emitting diode lamp controller receives a control signal and in response, turns-on the first drive module.

17. The light emitting diode lamp according to claim 16, wherein the control signal is generated by a light sensor.

18. The light emitting diode lamp according to claim 16, wherein the control signal is generated by a timer.

19. The light emitting diode lamp according to claim 16, wherein the control signal is from a communications network.

20. The light emitting diode lamp according to claim 16, wherein the control signal is generated by a temperature sensor proximate to the first light emitting diode module.
